(19) United States
(12) Patent Application Publication
(10) Pub. No.: US 2014/0375895 A1
(43) Pub. Date: Dec. 25, 2014

(54) ELECTRONIC DEVICE, TELEVISION DEVICE, AND GUI INFORMATION COMMUNICATION METHOD

(71) Applicant: KABUSHIKI KAISHA TOSHIBA, Tokyo (JP)

(72) Inventors: Kosuke Haruki, Tokyo (JP); Takahiro Suzuki, Tokyo (JP)

(73) Assignee: KABUSHIKI KAISHA TOSHIBA, Tokyo (JP)

(21) Appl. No.: 14/069,159

(22) Filed: Oct. 31, 2013

Related U.S. Application Data
(63) Continuation of application No. PCT/JP2013/066834, filed on Jun. 19, 2013.

(51) Int. Cl. H04N 5/44

(52) U.S. Cl. CPC H04N 5/4403
USPC 348/734

(57) ABSTRACT

[Problem]

To make various settings on an electronic device with a simple technique, without increasing hardware cost.

[Solution]

An electronic device capable of communicating with a host device includes a setting information transmitter 5 which transmits, to the host device, setting screen generating information; an input information receiver 6 which receives setting information inputted into the host device by a user in accordance with the setting screen displayed on the display, in accordance with the setting screen generating information; and an operation setting unit 7 which makes a setting on operation of the electronic device.

### CROSS REFERENCE TO RELATED APPLICATIONS

This application is a Continuation Application of PCT Application No. PCT/JP2013/066834, filed Jun. 19, 2013, the entire contents of all of which are incorporated herein by reference.

### TECHNICAL FIELD

Embodiments of the present invention relate to an electronic device, a television device, and a GUI information communication method.

### BACKGROUND ART

Various settings on a wireless network and DHCP (Dynamic Host Configuration Protocol) of the network can be made by accessing an HTTP server provided in a machine handling these settings or by a user while using an original UI screen prepared for DTV (Digital Television), HDD recorder, etc. In both cases, a processor having an adequate computational performance has to be mounted on the machine handling these settings.

### CITATION LIST

[Patent Literature 1] JP-A 2012-226310 (Kokai)

[Patent Literature 2] JP-A 2010-28283 (Kokai)

[Patent Literature 3] Pamphlet of WO2008/013131

### SUMMARY OF INVENTION

### Technical Problem

An architecture in which functions commonly used all over the world are mounted on a common board and functions added as extended functions are mounted on an expansion board has to be considered to satisfy the demand for cost reduction of DTVs.

Due to high demand for cost reduction of the DTV, not only the common board but also the expansion board is targeted for cost reduction. If a low-cost powerless processor is mounted on the expansion board to reduce the cost of the expansion board, the limited processing capacity makes it difficult to provide an HTTP server in the expansion board.

The present invention has been made to provide an electronic device, a television device, and a GUI information communication method capable of making various settings on the electronic device with a simple technique without increasing hardware cost.

### Solution to Problem

To be provided in an aspect of the present embodiment is an electronic device capable of communicating with a host device through at least one of a wired connection and a wireless connection. This electronic device includes: a setting information transmitter which transmits, to the host device, setting screen generating information required to generate a setting screen for the electronic device to be displayed on a display of the host device; an input information receiver which receives setting information inputted into the host device by a user based on the setting screen displayed on the display, in accordance with the setting screen generating information; and an operation setting unit which makes a setting on operation of the electronic device, based on the received setting information.

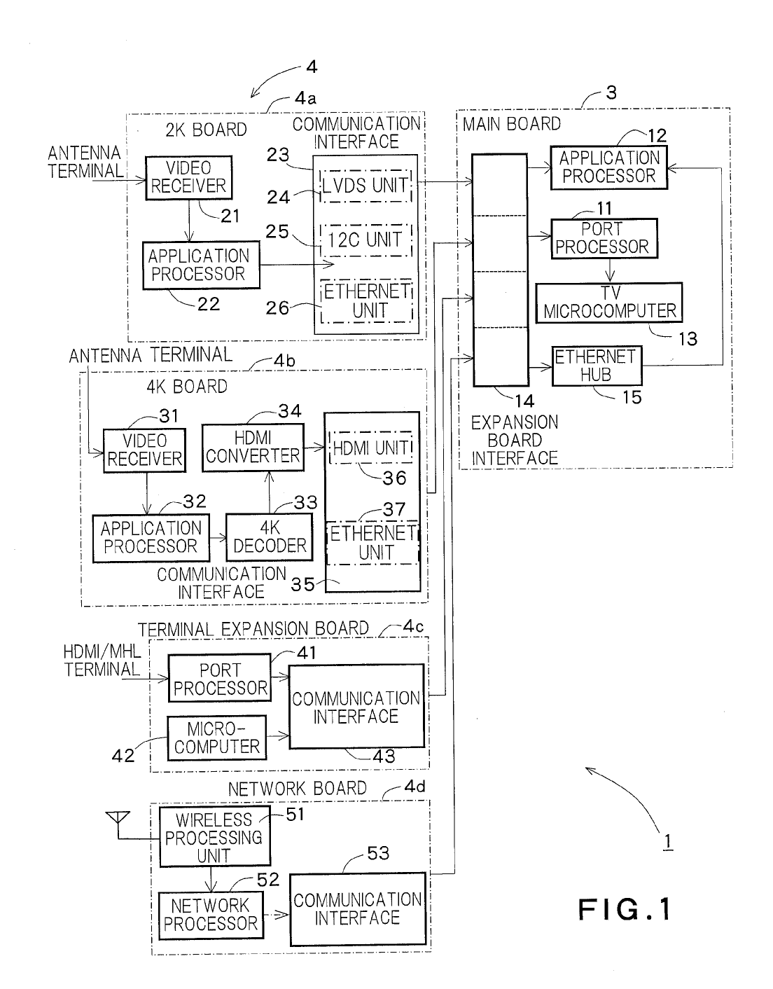

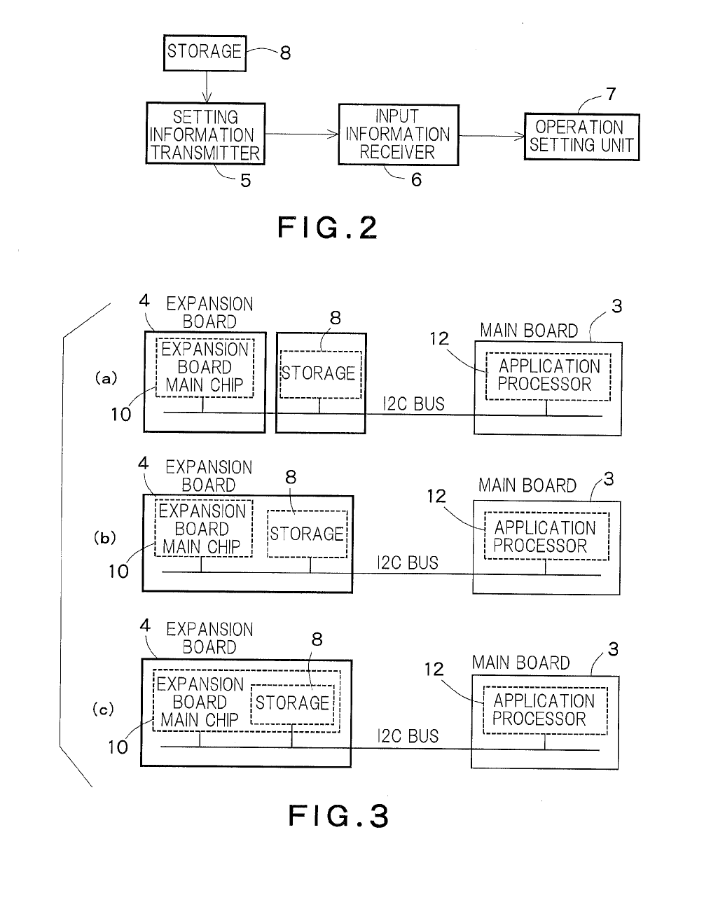

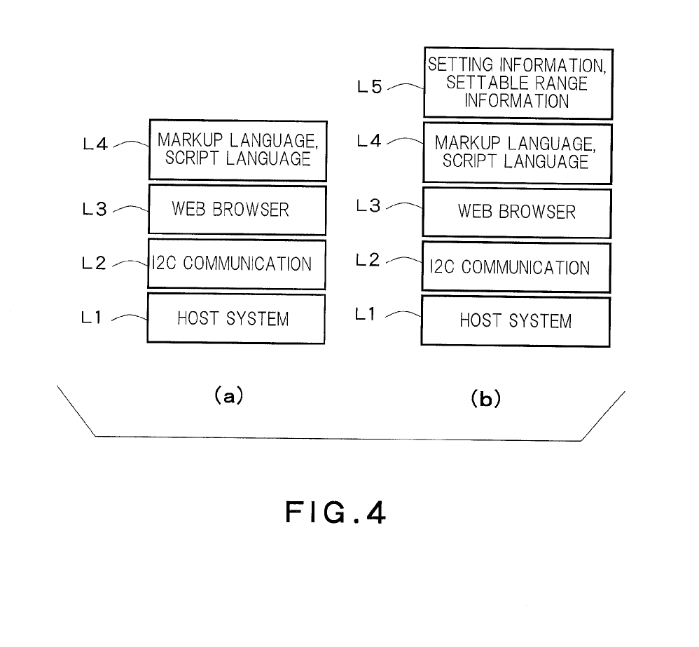

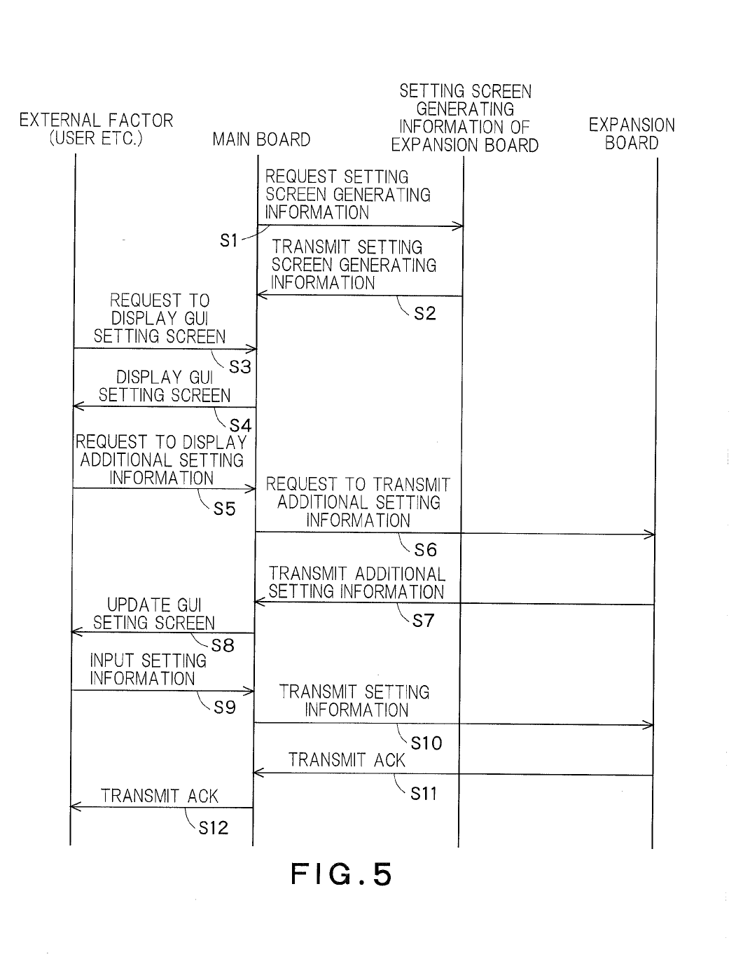

### BRIEF DESCRIPTION OF DRAWINGS

[FIG. 1] A block diagram showing a schematic structure of a television device 1 according to the present embodiment.

[FIG. 2] A functional block diagram for making various settings on an expansion board 4.

[FIG. 3] Diagrams (a) to (c) each showing how to connect a main chip 10 of the expansion board 4 to a storage 8.

[FIG. 4] Software stack diagrams (a) and (b) each hierarchically showing software executed by an application processor 12 of a main board 3.

[FIG. 5] A sequence diagram of information transmitted and received between the main board 3 and the expansion board 4.

### DESCRIPTION OF EMBODIMENTS

Hereinafter, an embodiment of the present invention will be explained referring to the drawings.

FIG. 1 is a block diagram showing a schematic structure of a television device (host device) 1 according to the present embodiment. At least one expansion board (electronic device) can be incorporated into or connected to the television device 1.

The television device 1 of FIG. 1 is based on the above-mentioned architecture, and has a display 2, a main board 3 commonly used all over the world, and one or more expansion boards 4 communicating with the main board 3 through at least one of a wired connection and a wireless connection.

As shown in FIG. 1, the main board 3 has a port processor 11, an application processor 12, a TV microcomputer 13, expansion board interfaces 14, and an Ethernet hub 15.

The port processor 11 performs control for switching and expanding HDMI (High-Definition Multimedia Interface).

The application processor 12 generates image data and audio data to be outputted to the display 2, based on the video and audio data transferred through an HDMI terminal switched by the port processor 11 or through another route.

The TV microcomputer 13 receives a signal from e.g. a remote controller (not shown) to control the power source, channel, etc. of the television device 1. The TV microcomputer 13 continuously operates even when the port processor 11 and the application processor 12 stop their operations.

The expansion board interfaces 14 are provided corresponding to the respective expansion boards 4. When an expansion board 4 is connected, its corresponding expansion board interface 14 performs authentication and communication with the expansion board 4. The expansion boards 4 and the main board 3 communicate with each other using I2C (Inter-Integrated Circuit) and Ethernet, for example. The expansion board 4 may be accommodated in a housing having the main board 3 of the television device 1 therein, or may be accommodated in a housing separated from this housing.

FIG. 1 shows four kinds of expansion boards 4, but the kinds or number of expansion boards 4 should not be limited to the example of FIG. 1. Some expansion boards 4 are manufactured based on the specifications differing depending on the country or district, and some are commonly used all over the world although lacking an essential function for the television device 1.

In the example shown in FIG. 1, a 2K board 4a, a 4K board 4b, a terminal expansion board 4c, and a network board 4d are provided as the expansion boards 4. An expansion board 4 is arbitrarily selected from these four expansion boards 4a to 4d as needed, and incorporated into or connected to the television device 1.

The 2K board 4a has a video receiver 21, an application processor 22, and a communication interface 23. The video receiver 21 selects and demodulates a television signal received by an antenna (not shown) to convert it into a digital signal. The application processor 22 separates the digital signal outputted from the video receiver 21 into video data and audio data. The communication interface 23 has an LVDS (Low Voltage Differential Signaling) unit 24, an I2S (Inter-IC Sound) unit 25, and an Ethernet unit 26. The LVDS unit 24 performs control for transferring the video data differentially. The I2S unit 25 performs control for transferring the audio data serially.

The 4K board 4b has a video receiver 31, an application processor 32, a 4K decoder 33, an HDMI converter 34, and a communication interface 35. The 4K decoder 33 is a decoder dedicated to 4K data. The HDMI converter 34 converts the data into HDMI 2.0 compliant data. The communication interface 35 has an HDMI unit 36 and an Ethernet unit 37. The HDMI unit 36 performs control for transferring both of the video data and audio data based on the HDMI 2.0 standard.

The terminal expansion board 4c has a port processor 41, a microcomputer 42, and a communication interface 43. The port processor 41 performs control for newly adding an HDMI terminal or an MHL (Mobile High-definition Link) terminal.

The network board 4d has a wireless processing unit 51, a network processor 52, and a communication interface 53. The wireless processing unit 51 performs a process based on a wireless LAN standard such as IEEE 802.11n. The network processor 52 controls the communication via the wireless LAN and Ethernet.

As shown in FIG. 1, various types of expansion boards 4 can be connected to the main board 3, and an expansion board different from the expansion boards 4 shown in FIG. 1 may be incorporated into or connected to the television device 1. Hereinafter, these various expansion boards are collectively called as expansion board 4.

As shown in FIG. 1, the expansion board 4 according to the present embodiment has one or more processors incorporated therein. Each of these processors executes a program previously given. In the processes to be executed by the processor, a process common to every expansion board 4 can be expressed as a functional block diagram as shown in FIG. 2, for example. Note that at least a part of blocks shown in FIG. 2 may be executed by a hardware unit mounted on the expansion board 4, not by the software executed by the processor.

More concretely, FIG. 2 is a functional block diagram for making various settings on the expansion board 4. In the present embodiment, when the expansion board 4 is connected to the main board 3 of the television device 1, a GUI setting screen for this expansion board 4 is displayed on the display 2 of the television device 1 so that the user can make various settings in accordance with this GUI setting screen. The user inputs settings on the GUI setting screen by operating e.g. a remote controller supplied with the television device 1.

The functional block diagram of FIG. 2 of the expansion board 4 includes a setting information transmitter 5, an input information receiver 6, an operation setting unit 7, and a storage 8. The setting information transmitter 5 transmits, to the main board 3, setting screen generating information required to generate a GUI setting screen for the expansion board 4 to be displayed on the display 2 of the television device 1. The input information receiver 6 receives setting information inputted by the user in accordance with the GUI setting screen displayed on the display 2 by using e.g. a remote controller of the television device 1, in accordance with the setting screen generating information. The operation setting unit 7 makes settings on the operation of the expansion board 4, based on the received setting information.

The setting screen generating information is described in e.g. at least one of markup language and script language for automatically which generate the GUI setting screen to be displayed on the display 2 of the television device 1. Here, the markup language is e.g. HTML (Hyper Text Markup Language), and the script language is e.g. JavaScript.

When the setting screen generating information is described by the markup language or script language as stated above, the main board 3 can display the GUI setting screen easily by parsing the received setting screen generating information, which means that processing load on the application processor 12 on the main board 3 can be considerably reduced.

The setting screen generating information of the expansion board 4 is different depending on each expansion board 4, and previously created by a vendor developing and manufacturing the expansion board 4. Each vendor creates the setting screen generating information considering the hardware performance of the television device 1 (e.g., display resolution, display position, display size, etc. of the GUI setting screen), in accordance with the design specifications provided by the assembly manufacturer developing the television device 1. The created setting screen generating information is stored on the expansion board 4 or in the storage 8 mounted on a board different from the expansion board 4. Since the setting screen generating information is not rewritten frequently, the storage 8 can be formed as a ROM (Read Only Memory), into which information can be written only once. Instead, the storage 8 may be formed as a flash memory, whose information can be electrically rewritten and erased, in order to update the setting screen generating information in the future.

As shown in FIG. 3(a), FIG. 3(b) and FIG. 3(c), there are three patterns to connect the storage 8 to the processor (hereinafter referred to as a main chip 10) of the expansion board 4 for performing the process of FIG. 2.

The expansion board 4 of FIG. 3(a) has a sub-board on which the main chip 10 is mounted and a sub-board on which the storage 8 is mounted. These two sub-boards are connected through an I2C bus. In the case of FIG. 3(a), the main board 3 can directly access each of the main chip 10 and storage 8 using I2C communication commands.

The expansion board 4 of FIG. 3(b) has the main chip 10 and storage 8 mounted on the same board. The main chip 10 and storage 8 are connected to the I2C bus. Also in the case of FIG. 3(b), where only one expansion board 4 is provided, the main board 3 can directly access each of the main chip 10 and storage 8 using I2C communication commands.

In the expansion board 4 of FIG. 3(c), the storage 8 is provided in the main chip 10 and the main chip 10 is connected to the I2C bus. In the case of FIG. 3(c), the main board 3 reads the setting screen generating information stored in the storage 8 through the main chip 10.

Note that the setting screen generating information stored in the storage 8 should not be necessarily described by the markup language or script language. For example, the setting screen generating information may be concrete setting information or settable range information described on the GUI setting screen displayed on the television device 1. In this case, the main board 3 when receiving the setting screen generating information must generate image information for displaying the GUI setting screen, which increases the load on the development of software for the main board. Note that since the information required to generate the GUI setting screen is included in the setting screen generating information, the main board 3 can generate the GUI setting screen without previously grasping the functions and specifications of the expansion board 4.

FIG. 4 is a software stack diagram hierarchically showing software executed by the application processor 12 of the main board 3. FIG. 4(a) shows a software stack diagram when the setting screen generating information received from the expansion board 4 is described by the markup language or script language. FIG. 4(b) shows a software stack diagram when the setting screen generating information received from the expansion board 4 is described as concrete setting information or settable range information.

In the case of FIG. 4(a), the first hierarchy L1 as the lowermost layer has a host system executed by the application processor 12 on the main board 3, and the second hierarchy L2 situated on L1 has software for controlling the I2C communication. The software in the second hierarchy L2 is used to receive the setting screen generating information from the expansion board 4. The third hierarchy L3 situated on L2 has a Web browser for displaying the GUI setting screen by parsing the markup language or script language included in the setting screen generating information. The fourth hierarchy L4 situated on L3 has the markup language or script language included in the setting screen generating information.

As stated above, in the case of FIG. 4(a), the main board 3 can display the GUI setting screen for the expansion board 4 only by executing the markup language or script language included in the setting screen generating information. Further, setting information inputted by the user in accordance with this GUI setting screen can also be transmitted to the expansion board 4 through the I2C communication, in accordance with the description by the markup language or script language included in the setting screen generating information.

On the other hand, in FIG. 4(b), the first to fourth hierarchies L1 to L4 are the same as those of FIG. 4(a), but the fifth hierarchy L5 is further provided on L4. This fifth hierarchy L5 has setting information and settable range information included in the setting screen generating information transmitted from the expansion board 4. Based on these information, the main board 3 can generate description by the markup language or script language in the third hierarchy L3 to be executed by the Web browser.

Based on the setting information and settable range information included in the setting screen generating information, the application processor 12 can generate description by the markup language or script language to display the GUI setting screen.

Both in FIG. 4(a) and FIG. 4(b), even when detailed functions and specifications of the expansion board 4 are not given, the main board 3 interpreting I2C communication commands can display the GUI setting screen based on the setting screen generating information, and can transmit, to the expansion board 4, the setting information inputted by the user in accordance with the GUI setting screen.

FIG. 5 is a sequence diagram of information transmitted and received between the main board 3 and the expansion board 4. FIG. 5 shows how the information is transmitted and received among an external factor (user etc.), the main board 3, the setting screen generating information of the expansion board 4, and the expansion board 4. The setting screen generating information of the expansion board 4 is stored in a ROM or the main chip 10 on the expansion board 4, for example.

When the expansion board 4 is connected to the main board 3, the main board 3 requests the expansion board 4 to transmit setting screen generating information (Step S1). In accordance with this request, the setting screen generating information is transmitted to the main board 3 (Step S2).

After that, the external factor (user etc.) requests the main board 3 to display a GUI setting screen (Step S3). In accordance with this request, the main board 3 displays a GUI setting screen based on the setting screen generating information transmitted in Step S2 (Step S4).

Next, when the external factor (user etc.) requests the main board 3 to display additional setting information on the GUI setting screen (Step S5), the main board 3 requests the expansion board 4 to transmit the additional setting information (Step S6). When the expansion board 4 receiving this request transmits the setting information (Step S7), the main board 3 updates the GUI setting screen (Step S8).

Next, when the external factor (user etc.) inputs setting information in accordance with the GUI setting screen (Step S9), the setting information is transmitted from the main board 3 to the expansion board 4 through I2C communication (Step S10). Upon receiving the setting information from the main board 3, the expansion board 4 transmits, to the main board 3, ACK information showing safe receipt (Step S11), and the main board 3 transmits the ACK information to the external factor (user etc.) (Step S12).

As stated above, in the present embodiment, when the expansion board 4 is connected to the main board 3, setting screen generating information required to generate a GUI setting screen for the expansion board 4 is transmitted from the expansion board 4 to the main board 3, so that the main board 3 receiving the setting screen generating information can easily display the GUI setting screen in accordance with the setting screen generating information. That is, the main board 3 can display the GUI setting screen for the expansion board 4 without grasping detailed functions and specifications of the expansion board 4.

Further, when the expansion board 4 updates the setting screen generating information stored in the storage 8 and transmits the updated information to the main board 3, the GUI setting screen can be updated without changing hardware configuration.

Furthermore, the expansion board 4 can create the setting screen generating information for the GUI setting screen independently of the process performed by the main board 3.

In the examples explained in the above embodiment, the expansion board 4 can be incorporated into or connected to the television device 1. However, the present embodiment can be widely applied to an electronic device capable of communicating with a host device through at least one of a wired connection and a wireless connection.

At least a part of the television device 1 explained in the above embodiments may be formed of hardware or software. In the case of software, a program realizing at least a partial function of the television device 1 may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc.

Further, a program realizing at least a partial function of the television device 1 can be distributed through a communication line (including radio communication) such as the Internet. Furthermore, this program may be encrypted, modulated, and compressed to be distributed through a wired line or a radio link such as the Internet or through a recording medium storing it therein.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

1 television device, 2 display, 3 main board, 4 expansion board, 10 main chip, 11 port processor, 12 application processor, 13 TV microcomputer, 14 expansion board interface, 15 Ethernet hub

1. An expansion board attachable to and detachable from a host device and communicating with the host device through at least one of a wired connection or a wireless connection, comprising:
a transmitter to transmit, to the host device, setting screen generating information to generate a setting screen for the expansion board to be displayed on a display of the host device when the expansion board is connected to the host device;
a receiver to receive setting information input into the host device by a user based on the setting screen displayed on the display, in a format described in the setting screen generating information; and
a processor to make a setting on operation of the expansion board, based on the received setting information,
wherein the setting screen generating information comprises first information used for automatically generating the setting screen displayed on the display and second information concerning a manner to transmit the setting information to the expansion board, and the first information and the second information described in at least one of a markup language or a script language.

2. The expansion board of claim 1, wherein each of the transmitter and the receiver communicates with the host device using an I2C (Inter-Integrated Circuit) communication and Ethernet.

3. The expansion board of claim 1, wherein the setting screen generating information is information described by at least one of a markup language or a script language for automatically generating the setting screen to be displayed on the display.

4. The expansion board of claim 3, wherein at least one of the markup language or the script language is at least one of HyperText Markup Language (HTML) or JavaScript.

5. (canceled)

6. (canceled)

7. The expansion board of claim 1, further comprising:
a storage to store the setting screen generating information,
wherein the transmitter transmits, to the host device, the setting screen generating information read from the storage.

8. The expansion board of claim 7, wherein when the setting screen generating information stored in the storage is updated, the transmitter newly transmits the updated setting screen generating information to the host device.

9. The expansion board of claim 1,
wherein the host device is a television device, and
the expansion board is a board capable of being incorporated into or connected to the television device to expand a function of the television device.

10. A television device into or to which at least one expansion board can be incorporated or connected, comprising:
a receiver to receive setting screen generating information transmitted from the expansion board, the setting screen generating information being required to generate a setting screen for the expansion board to be displayed on the television device;
a setting screen generator to generate the setting screen for the expansion board, based on the setting screen generating information;
a display to display the generated setting screen;
a setting input unit to enable a user to input setting information on operation of the expansion board, in accordance with the setting screen; and
a transmitter to transmit, to the expansion board, the setting information on the operation of the expansion board input by the user using the setting input unit, in a format described in the setting screen generating information,
wherein the setting screen generating information comprises first information used for automatically generating the setting screen displayed on the display and second information concerning a manner to transmit the setting information to the expansion board, and the first information and the second information described in at least one of a markup language or a script language.

11. The television device of claim 10, wherein each of the receiver and the transmitter communicates with the expansion board using an I2C (Inter-Integrated Circuit) communication and Ethernet.

12. (canceled)

13. The television device of claim 10, wherein at least one of the markup language or the script language is at least one of HyperText Markup Language (HTML) or JavaScript.

14. (canceled)

15. The television device of claim 10, wherein the setting screen generating information includes at least one of setting information or settable range information on the expansion board, the setting information or the settable range information being included in the setting screen to be displayed on the display.

16. A method comprising:
transmitting to a host device from an expansion board, which is attachable to and detachable from the host device and communicating with the host device through at least one of a wired connection or a wireless connection setting screen generating information to generate a setting screen for the expansion board;
receiving setting information by the expansion board from the host device, wherein the setting information being input into the host device by a user based on the setting screen displayed on the display, in a format described in the setting screen generating information; and
setting on operation of the expansion board, based on the received setting information,
wherein the setting screen generating information comprises first information used for automatically generating the setting screen displayed on the display and second information concerning a manner to transmit the setting information to the expansion board and, the first information and the second information described in at least one of a markup language or a script language.

17. The method of claim 16, wherein an I2C (Inter-Integrated Circuit) communication and Ethernet are used when the expansion board transmits the setting screen generating information to the host device and when the expansion board receives the setting information from the host device.

18. (canceled)

19. The method of claim 16, wherein at least one of the markup language or the script language is at least one of HyperText Markup Language (HTML) or JavaScript.

20. (canceled)
